(19) United States
(12) Patent Application Publication
(10) Pub. No.: US 2014/0203128 A1
(43) Pub. Date: Jul. 24, 2014

(54) SHELL SUPPORTED GRINDING MILL

(71) Applicant: METSO MINERALS INDUSTRIES, INC., Waukesha, WI (US)

(72) Inventors: Richard E. Enders, Hummelstown, PA (US); Charles Golembewski, York, PA (US)

(73) Assignee: METSO MINERALS INDUSTRIES, INC., Waukesha, WI (US)

(21) Appl. No.: 13/744,796

(22) Filed: Jan. 18, 2013

(51) Int. Cl. B02C 17/18

(52) U.S. Cl. CPC B02C 17/18
USPC 241/176

(57) ABSTRACT

A grinding mill comprising an essentially horizontally oriented, rotatable drum, a support bearing supporting the drum, and a riding ring connecting the drum to the support bearing is provided. The drum has a circumferential wall having a first end and a second end, a first end wall arranged at the first end of the circumferential wall, and a second end wall arranged at the second end of the circumferential wall. The riding ring is integrally formed with the first end wall.

### TECHNICAL FIELD OF THE INVENTION

The present invention relates to a grinding mill comprising an essentially horizontally oriented, rotatable drum, a support bearing supporting said drum, and a riding ring connecting said drum to said support bearing.

### BACKGROUND ART

Grinding mills are normally used to grind mine ore or primary crusher product. One type of mill comprises a horizontally oriented drum, in which the material to be ground, i.e. the charge, is ground by rotating the drum. The charge is ground by the action of impacts of the charge on the inside wall surface of the drum, as well as impacts of portions of the charge with each other. In a particular type of horizontal drum mill, called a Ball mill, balls of hard material, are introduced in the drum, with the charge. When the drum is rotated, the charge is ground also by the action of impacts from the balls. A similar type of horizontal drum mill is called a Pebble mill. In this, pebbles are introduced in the drum, instead of balls. Other types of horizontal drum mills are Autogenous mills (AG mills) and Semi-Autogenous mills (SAG mills).The mill product can either be finished size ready for processing, or an intermediate size ready for final grinding in a second grinding mill, such as a Ball mill, Autogenous or Semi-Autogenous mill. Grinding may be dry or wet. Wet grinding may be accomplished in a wet mixture of, e.g., 50 to 80 percent solids. Generally, horizontal drum mills may be divided into two types, depending on how the drum is driven, namely shell supported mills and turret supported mills. There are, however, problems associated with some shell supported grinding mills available on the market today. The existing design of the grinding mills creates a large bending moment on the parts of the drum where it is supported. Gradually, cracks can develop in these areas making the entire construction unstable. Weld repair of these cracks may cause considerable down-time and additional damage due to heat and distortion.

### SUMMARY OF THE INVENTION

It is an objective of the present invention to provide an improvement of the above technique and prior art. More particularly, it is an objective of this invention to provide an improved grinding mill having an increased service life.

These and other objectives, and/or advantages that will be apparent from the following description of embodiments, are achieved, in full or at least in part, by a grinding mill comprising an essentially horizontally oriented, rotatable drum, a support bearing supporting said drum, and a riding ring connecting the drum to the support bearing. The drum has a circumferential wall or shell, having a first end and a second end, a first end wall arranged at the first end of the circumferential wall, and a second end wall arranged at the second end of the circumferential wall. The riding ring is integrally formed with the first end wall. This is advantageous in that the support bearing load stresses will go straight into the first end wall, through the riding ring, without causing a large bending moment, which could lead to premature failure of the construction. This will also allow the designer, when desired, to shift the riding ring and support bearing centerline relative to the end wall to control the stress profile and bending moments which can increase the fatigue life of the grinding mill structure. In turn, this will also allow a thinner design of the first end wall, thereby reducing material costs.

The drum may further comprise a flange portion extending in a radial direction essentially perpendicular to the circumferential wall, wherein the flange is attached to the first end wall. This design makes the riding ring and end wall assembly easy to detach from the shell if any parts need to be replaced.

The flange may be bolted to the first end wall, or the circumferential wall may be bolted to the first end wall, thereby avoid welding as an attachment means. By having a design that is bolted, it can be split up into smaller parts which allow the shipment of the grinding mill using conventional transportation methods. Another advantage which is achieved by bolting the flange of the drum to the first end wall is that the seam may be very tightly sealed. It should be noted that a problem associated with shell supported grinding mills exists, in that the seam between the circumferential wall and the end wall, gradually will start to leak and may thereafter disadvantageously function as a pump during rotation of the drum, pumping out slurry from the drum towards the adjacent parts of the grinding mill. This is particularly disadvantageous if the support bearing is contaminated by the slurry, since that may impair the function of the support bearing.

The first end wall may be welded to the circumferential wall. Welding is a simple and cost efficient way to attach these parts to each other.

The grinding mill may further comprise a weld joint attaching the first end wall to the circumferential wall, or a weld joint attaching the first end wall to the flange. The welding joint may also reinforce the bolted attachment of these parts to each other, and thereby further increase the overall stability of the grinding mill.

The riding ring may comprise an axial groove, and the support bearing may comprise a protrusion, wherein the protrusion is arranged to engage with the groove. The engagement between the two parts creates stability and increases the safety around the grinding mill during use. Also, axial movement of the drum will be prevented.

The riding ring may comprise an axial protrusion and the support bearing may have a groove, the protrusion being arranged to engage with the groove. The engagement between the two parts creates stability and increases the safety around the grinding mill during use. Also, axial movement of the drum will be prevented.

The grinding mill may be a Ball mill, an Autogenous (AG) mill, a Semi-Autogenous (SAG) mill, a Pebble mill or a Rod mill.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

Further, as used herein, the term “integrally formed” means that two or more parts are formed in one piece. This may be done, e.g., by forging or welding, but generally does not include bolting.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, and wherein:

FIG. 1 is a perspective view of a grinding mill according to one exemplary embodiment,

FIG. 2a is a partial cross section of the grinding mill in FIG. 1,

FIG. 2b is an enlarged view of part of the grinding mill as illustrated in FIG. 2,

FIG. 3a is a cross-sectional view of the detail illustrated in FIG. 2b according to a first embodiment,

FIG. 3b is a cross-sectional view of the detail illustrated in FIG. 2b according to a second embodiment,

FIG. 3c is a cross-sectional view of the detail illustrated in FIG. 2b according to a third embodiment,

FIG. 3d is a cross-sectional view of the detail illustrated in FIG. 2b according to a fourth embodiment,

FIG. 3e is a cross-sectional view of the detail illustrated in FIG. 2b according to a fifth embodiment,

FIG. 3f is a cross-sectional view of the detail illustrated in FIG. 2b according to a sixth embodiment,

FIG. 3g is a cross-sectional view of the detail illustrated in FIG. 2b according to a seventh embodiment,

FIG. 3h is a cross-sectional view of the detail illustrated in FIG. 2b according to an eighth embodiment, and

FIG. 3i is a cross-sectional view of the detail illustrated in FIG. 2b according to a ninth embodiment.

### DETAILED DESCRIPTION OF PREFERRED EMBODIMENTS OF THE INVENTION

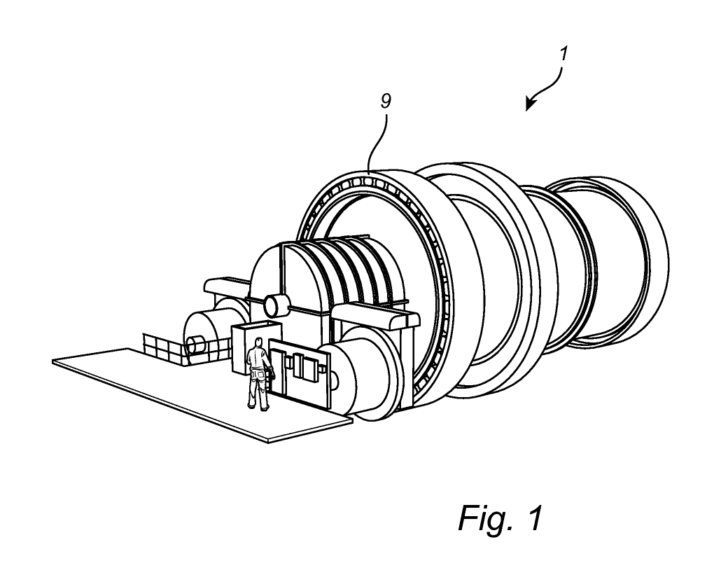

FIG. 1 illustrates a shell supported grinding mill 1 according to one exemplary embodiment of the invention. The grinding mill 1 may be any type of mill suitable for grinding, such as a Ball mill, an Autogenous (AG) mill, a Semi-Autogenous (SAG) mill, a Pebble mill or a Rod mill, and is mainly used for grinding ore material.

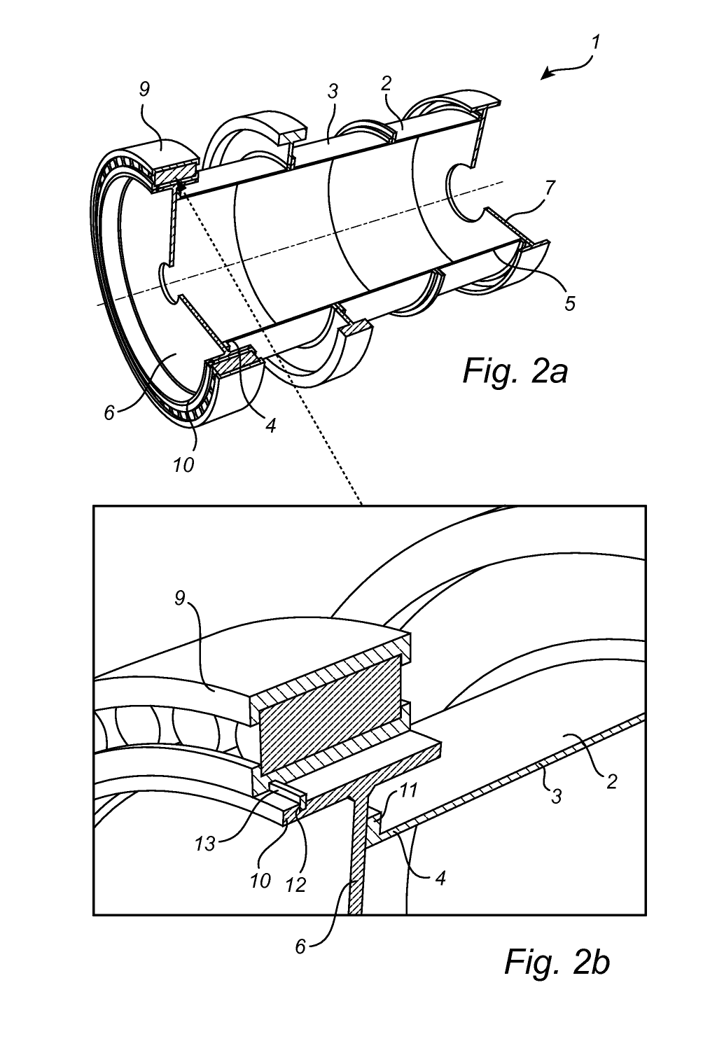

In FIG. 2a, a partial cross section of the grinding mill 1 in FIG. 1 is illustrated. The grinding mill 1 has an essentially horizontally oriented, rotatable drum 2. The drum 2 has a circumferential wall 3 (hereinafter referred to as shell) having a first end 4 and a second end 5, a first end wall 6 (hereinafter referred to as first head) located at the first end 4 of the shell 3, and a second end wall 7 (hereinafter referred to as second head) located at the second end 5 of the shell 3. In addition, the grinding mill 1 has a support bearing 9 which is supporting the drum 2, and a riding ring 10 connecting the drum 2 to the support bearing 9. The riding ring 10 is integrally formed with the first head 6. As may be seen more clearly in the detail in FIG. 2b, the drum 2 has a flange portion 11 which extends in a radial direction perpendicular to the shell 3.

The flange portion 11 of the drum 2 is attached to the first head 6, thereby also attaching the drum 2 to the riding ring 10. The riding ring 10 comprises a groove 12 (hereinafter referred to as thrust groove) and the support bearing 9 comprises a protrusion 13 (hereinafter referred to as thrust pad). The thrust pad 13 engages with the thrust groove 12, improving the stability, limiting the axial movement of the drum, and increasing the safety around the grinding mill 1 during use.

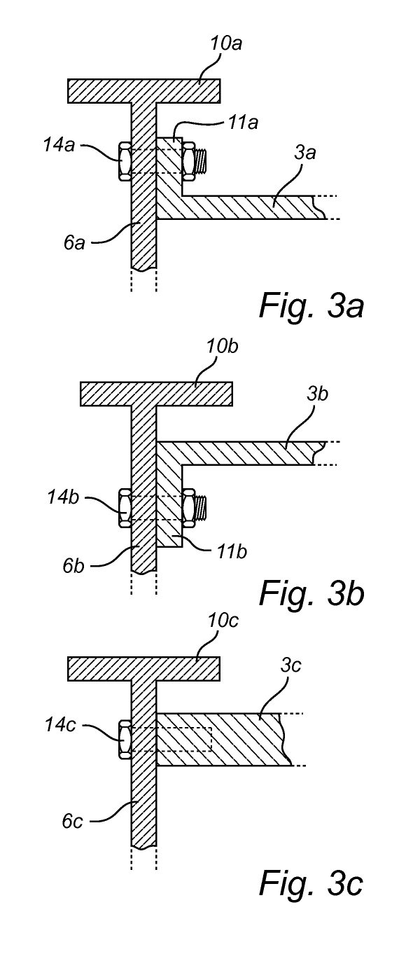

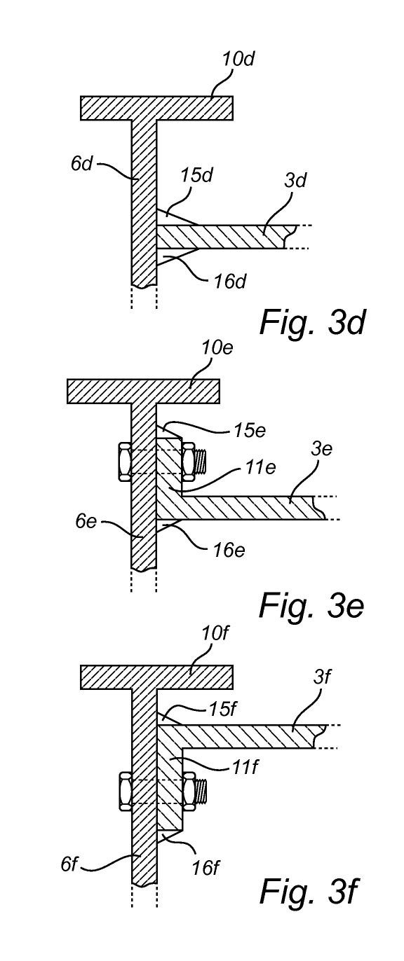

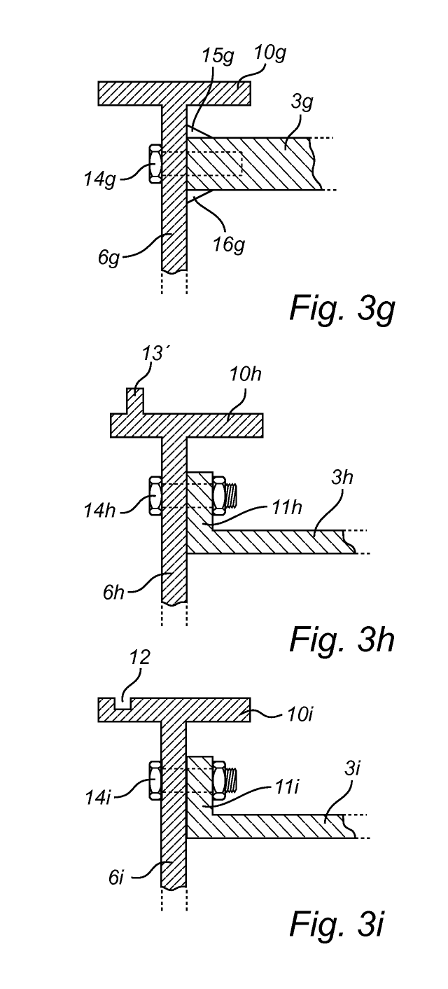

The attachment of the first head 6, and hence the riding ring 10, to the shell 3 of the drum 2 may be varied in many ways. FIGS. 3a-3i show nine embodiments. It should be noted that, a common feature of all these embodiments is that the riding ring 10 is integrally formed with the first head 6.

As may be seen in FIG. 3a, the flange 11a is directed radially outwardly from the shell 3. The flange 11a in this embodiment is bolted to the first head 6a by means of a bolt 14a. Thus, the first head 6a and riding ring 10a are connected to the shell 3a.

In the embodiment shown in FIG. 3b, the flange 11b is directed radially inwardly from the shell 3b. As in the previous embodiment, the first head 6b is bolted to the flange 11b by means of a bolt 14b, and in this manner, the first head 6b and riding ring 10b are connected to the shell 3b.

In the embodiment shown in FIG. 3c, the shell 3c is not provided with a flange. Instead, the first head 6c is bolted to the shell 3c by a bolt 14c threaded into the thickness of the shell 3c. Thus, the first head 6c and riding ring 10c are connected to the shell 3c.

FIG. 3d shows an embodiment similar to the one in FIG. 3c, but here, the first head 6d is welded to the shell 3d by means of weld joints 15d, 16d. Thus, the first head 6d and riding ring 10d are connected to the shell 3d.

FIG. 3e shows an embodiment similar to the one shown in FIG. 3a, but here the joint between the first head 6e and the flange 11e is reinforced by weld joints 15e, 16e. Here, also, the first head 6e and riding ring 10e are connected to the shell 3e.

Similarly, FIG. 3f shows an embodiment similar to the one shown in FIG. 3b, but with the joint between the first head 6f and the flange 11f reinforced by weld joints 15f, 16f. Here, also, the first head 6f and riding ring 10f are connected to the shell 3f.

The embodiment shown in FIG. 3g is similar to the one shown in FIG. 3c, but with the joint between the first head 6g and the shell 3g reinforced by weld joints 15g, 16g. Also in this embodiment, the first head 6g and riding ring 10g are connected to the shell 3g.

FIG. 3h shows an embodiment in which the riding ring 10h is provided with a thrust pad 13′, intended to engage with a corresponding thrust groove in the support bearing. This thrust pad 13′ may be referred to as a thrust ring. In all other respects, this embodiment corresponds to the one shown in FIG. 3a.

FIG. 3i shows an embodiment in which the riding ring 10i is provided with a thrust groove 12, intended to engage with a thrust pad in the support bearing. In all other respects, this embodiment corresponds to the one shown in FIG. 3a.

Although the embodiments shown in FIGS. 3a-3i are different in some respects, they have a number of advantages in common. For instance, compared to many known grinding mills, the fact that the riding ring is integrally formed with the first end wall reduces the number of components, and hence, the amount of work needed for assembly of the grinding mill.

Further, making the riding ring part of the first head, instead of a part of the shell may make it easier to manufacture the shell and the first head.

Additionally, integration of the riding ring with the first head may make it easier to maintain a tight seal between the first head and the shell, thereby reducing the risk of slurry leaking from the drum and getting inside the support bearing.

Because the riding ring is integral with the first head, a riding ring of a different diameter may be fitted on either end of the same drum.

Particularly if the first head is bolted to the shell, replacement of the first head is possible without having to replace the entire drum.

Additionally, the first head may be centered in relation to the riding ring, as illustrated in FIGS. 3a, 3c, 3e, 3g and 3i.

The first head may also be displaced in relation to the riding ring, as illustrated in FIGS. 3b, 3d, 3f and 3h.

The skilled person realizes that a number of modifications of the embodiments described herein are possible without departing from the scope of the invention, which is defined in the appended claims.

For instance, the position of the thrust ring, or of the thrust groove, respectively, may be varied along the width of the riding ring, depending on the length of the drum, and depending on the loading conditions.

Even though the riding ring has here only been described as being provided on the first end wall, it may also be provided on the second end wall.

The first end wall may be the inlet head, and the second end wall may be the outlet head, or vice versa.

Naturally, the grinding mill may have two support bearings supporting the drum, one at each end of the drum. That would in turn imply two riding rings connecting the drum to the support bearings.

It should also be noted that the support bearing not necessarily extends around the entire circumference of the drum. In one embodiment, the support bearing only extends around a part of the circumference of the drum. Here, the support bearing may in turn, for example, be supported by a cradle.

The support bearing referred to throughout the application may be constituted by any suitable type of bearing, such as a roller bearing, a hydrostatic bearing, a hydrodynamic bearing or a ball bearing.

The shape and size of the drum may naturally be varied. The shape could, for instance, be cylindrical, with a cross-section that is circular, oval, square, or has three or more flat sides.

Further, the width of the riding ring may be varied, as may the distance between the riding ring and the outside of the shell.

The first head may be manufactured in one piece, but it may also be manufactured in segments that are assembled to the first end. The segments may, for instance, be 120°, 180°, or 90° segments. Manufacturing the first heads in segments may make it easier to manufacture grinding mills having larger diameters, which can simplify transportation. Bolted joints may be used to assemble the segments making up the head and riding ring.

1. A grinding mill comprising:
an essentially horizontally oriented, rotatable drum, said drum having:
a circumferential wall having a first end and a second end;
a first end wall arranged at said first end of said circumferential wall; and
a second end wall arranged at said second end of said circumferential wall;
a support bearing supporting said drum; and
a riding ring connecting said drum to said support bearing, wherein said riding ring is integrally formed with said first end wall.

2. A grinding mill as claimed in claim 1, wherein said drum further comprises a flange portion extending in a radial direction essentially perpendicular to said circumferential wall, said flange being attached to said first end wall.

3. A grinding mill according to claim 2, wherein said flange is bolted to said first end wall.

4. A grinding mill as claimed in claim 1, wherein said first end wall is bolted to said circumferential wall.

5. A grinding mill as claimed in claim 1, wherein said first end wall is welded to said circumferential wall.

6. A grinding mill as claimed in claim 1, further comprising a weld joint joining said first end wall to said circumferential wall.

7. A grinding mill as claimed in claim 1, further comprising a weld joint joining said first end wall to said flange.

8. A grinding mill as claimed in claim 1, wherein said riding ring comprises a groove, and said support bearing comprises a protrusion, said protrusion being arranged to engage with said groove.

9. A grinding mill according to claim 1, wherein said riding ring comprises a protrusion and said support bearing comprises a groove, said protrusion being arranged to engage with said groove.

10. A grinding mill according to claim 1, said grinding mill being a Ball mill, an Autogenous (AG) mill, a Semi-Autogenous (SAG) mill, a Pebble mill or a Rod mill.
